(19) United States
(12) Patent Application Publication
(10) Pub. No.: US 2016/0027565 A1
(43) Pub. Date: Jan. 28, 2016

(54) METHOD OF MANUFACTURING RARE EARTH MAGNET

(71) Applicant: TOYOTA JIDOSHA KABUSHIKI KAISHA, Toyota-shi (JP)

(72) Inventors: Akira KANO, Toyota-shi (JP); Daisuke SAKUMA, Nagoya-shi (JP)

(73) Assignee: TOYOTA JIDOSHA KABUSHIKI KAISHA, Toyota-shi (JP)

(21) Appl. No.: 14/808,510

(22) Filed: Jul. 24, 2015

(30) Foreign Application Priority Data
Jul. 25, 2014 (JP) 2014-151483

(51) Int. Cl. H01F 1/057; H01F 41/02; C22C 38/00; B22F 3/10; B22F 3/24

(52) U.S. Cl. CPC H01F 1/0577; B22F 3/10; B22F 3/24; C22C 38/005; C22C 38/002; H01F 41/0253; B22F 2003/248

(57) ABSTRACT

A method of manufacturing a rare earth magnet includes: a first step of manufacturing a sintered compact by press-forming a powder for the rare earth magnet; a second step of manufacturing a rare earth magnet precursor by performing hot deformation processing on the sintered compact to impart anisotropy to the sintered compact; and a third step of manufacturing the rare earth magnet by cooling the rare earth magnet precursor at a cooling rate of 10° C./sec or higher.

### INCORPORATION BY REFERENCE

The disclosure of Japanese Patent Application No. 2014-151483 filed on Jul. 25, 2014 including the specification, drawings and abstract is incorporated herein by reference in its entirety.

### BACKGROUND OF THE INVENTION

1. Field of the Invention

The present invention relates to a method of manufacturing a rare earth magnet.

2. Description of Related Art

Rare earth magnets made from rare earth elements are called permanent magnets and are used for driving motors of hybrid vehicles, electric vehicles, and the like as well as motors included in hard disks and MRIs.

As an index indicating magnetic performance of these rare earth magnets, for example, residual magnetization (residual magnetic flux density) and coercive force may be used. Along with a decrease in the size of a motor and an increase in current density, the amount of heat generation increases, and thus the demand for high heat resistance has further increased in rare earth magnets to be used. Accordingly, one of the important research issues in this technical field is how to hold the coercive force of a magnet when being used at a high temperature. A Nd—Fe—B-based magnet which is a widely used rare earth magnet in a vehicle driving motor will be described as an example. In this Nd—Fe—B-based magnet, an attempt to increase the coercive force thereof has been made, for example, by refining crystal grains, by using an alloy composition having a large amount of Nd, or by adding a heavy rare earth element such as Dy or Tb having high coercive force performance.

Examples of the rare earth magnets include commonly-used sintered magnets in which a grain size of crystal grains constituting a structure thereof is about 3 μm to 5 μm; and nanocrystalline magnets in which crystal grains are refined into a nano grain size of about 50 nm to 300 nm.

An example of a method of manufacturing a rare earth magnet will be briefly described. For example, a method of manufacturing a rare earth magnet (oriented magnet) is commonly used, this method including: rapidly solidifying Nd—Fe—B molten metal to obtain a quenched ribbon; crushing the quenched ribbon to prepare magnetic powder; hot-press-forming the magnetic powder into a sintered compact; and performing hot deformation processing on this sintered compact so as to impart magnetic anisotropy thereto.

In a sintered compact which is prepared by solidifying magnetic powder obtained using a liquid quenching method, crystals are not oriented, and the residual magnetic flux density is low. Therefore, strains are imparted to the sintered compact through hot deformation processing such as forging and extrusion to orient crystals.

It is known that coercive force has a correlation with grain size, and high coercive force can be obtained by refinement (several tens to several hundreds of nanometers) of grain size. However, it is also known that fine crystals are coarsened due to the amount of heat input during hot deformation processing, and thus both coercive force and residual magnetic flux density decrease. The present inventors focused on a phenomenon in which coercive force decreases after the following processes: small cracks are formed in crystals during the hot deformation processing; a grain boundary phase (in a state of being liquefied at a high temperature) near the formed cracks is drawn into the cracks; and the thickness of the grain boundary decreases.

As a technique of the related art for improving coercive force, Japanese Patent Application Publication No. 2013-45844 (JP 2013-45844 A) discloses a method of manufacturing a rare earth magnet, the method including: a step of quenching a melt of a rare earth magnet composition to form a quenched ribbon having a nanocrystalline structure; a step of sintering the quenched ribbon to obtain a sintered compact; a step of heat-treating the sintered compact at a temperature which is sufficiently high to allow a grain boundary phase to be diffused and flow and which is sufficiently low to prevent the coarsening of crystal grains; and a step of quenching the heat-treated sintered compact to 200° C. or lower at a cooling rate of 50° C./min or higher.

In this manufacturing method, the sintered compact is cooled at a cooling rate in the predetermined range to manufacture a rare earth magnet having high coercive force performance. However, this method cannot solve the above-described problem. That is, in a rare earth magnet precursor which is prepared by performing hot deformation processing on the sintered compact, the coercive force decreases due to cracks which may be formed in crystals during the hot deformation processing.

### SUMMARY OF THE INVENTION

The present invention provides a method of manufacturing a rare earth magnet capable of solving a decrease in coercive force due to cracks which may be formed in crystals during hot deformation processing.

A method of manufacturing a rare earth magnet according to an aspect of the invention includes: manufacturing a sintered compact by press-forming a powder for the rare earth magnet; manufacturing a rare earth magnet precursor by performing hot deformation processing on the sintered compact to impart anisotropy to the sintered compact; and manufacturing the rare earth magnet by cooling the rare earth magnet precursor at a cooling rate of 10° C./sec or higher.

In the method of manufacturing the rare earth magnet according to the invention, after the hot deformation processing, the rare earth magnet precursor is cooled, and the cooling rate thereof is controlled such that a liquid phase present in a grain boundary phase between crystals is rapidly immobilized (structure freezing). As a result, a decrease in the amount (thickness) of a liquid phase present in a grain boundary phase can be suppressed, in which the decrease is caused when the liquid phase aggregates in small cracks (internal vacuum) formed in crystals of the rare earth magnet precursor which is manufactured by hot deformation processing. Since the decrease in the amount of the liquid phase present in the grain boundary phase is suppressed, a decrease in the coercive force of the rare earth magnet precursor can be suppressed, and thus a rare earth magnet having superior coercive force performance can be manufactured.

The present inventors verified that, when a rare earth magnet precursor which is heated to, for example, 800° C. or higher due to hot deformation processing is cooled at a cooling rate of 10° C./sec or higher, a rare earth magnet having a higher coercive force can be obtained as compared to a case where the cooling rate is lower than 10° C./sec. In the manufacturing method according to the invention, the cooling rate of the rare earth magnet precursor in the third step is limited to be 10° C./sec or higher.

The present inventors found a new problem, which has not been discussed in the related art, that cracks formed in crystals during hot deformation processing cause a decrease in coercive force. As means for solving the problem, the present inventors adopted a new characteristic configuration of cooling a rare earth magnet precursor at a cooling rate in a predetermined range after hot deformation processing, thereby completing the manufacturing method according to the invention.

Simply, the rare earth magnet precursor is cooled for a short period of time after the hot deformation processing. Therefore, the manufacturing time and the manufacturing cost do not increase.

Here, the rare earth magnet which is a manufacturing target of the manufacturing method according to the invention includes a nanocrystalline magnet in which a grain size of a main phase (crystal) constituting a structure thereof is about 300 nm or less; and a sintered magnet having a grain size of more than 300 nm or a grain size of 1 μm or more.

In the first step, a magnetic powder having a structure which contains a main phase and a grain boundary phase is prepared. For example, magnetic powder for a rare earth magnet can be prepared by preparing a quenched ribbon, which is fine crystal grains, by liquid quenching and crushing the rapidly-quenched ribbon.

This magnetic powder is filled into, for example, a die and is sintered while being compressed by a punch to be bulked. As a result, an isotropic sintered compact is obtained. The structure of the sintered compact is represented by a compositional formula (Rl)ₓ(Rh)_{y}T_{z}BₛMₜ, where Rl represents one or more light rare earth elements containing Y, Rh represents a heavy rare earth element containing at least one of Dy and Tb, T represents a transition metal containing at least one of Fe, Ni, and Co, B represents boron, M represents at least one of Ti, Ga, Zn, Si, Al, Nb, Zr, Ni, Co, Mn, V, W, Ta, Ge, Cu, Cr, Hf, Mo, P, C, Mg, Hg, Ag, and Au, 12≦x≦20, 0≦y≦4z=100-x-y-s-t, 5≦s≦20, 0≦t≦3, and all the numerical values are represented by mass %, a main phase of the structure is formed of (RlRh)₂T₁₄B, and a content of a (RlRh)_{1.1}T₄B₄ phase in a grain boundary phase of the structure is more than 0 mass % and 50 mass % or less.

Examples of the hot deformation processing in the second step include upset forging and extrusion forging (forward extrusion forging and backward extrusion forging). A strain by processing is introduced into the sintered compact by using one method or a combination of two or more methods among the above-described hot deformation processing methods. Next, for example, high deformation is performed at a processing rate of 60% to 80%. As a result, a rare earth magnet having high orientation and superior magnetization performance is manufactured.

In another embodiment of the method of manufacturing a rare earth magnet according to the invention, in the third step, after the cooling of the rare earth magnet precursor, an annealing treatment is performed.

The distance between crystals (the width of the grain boundary phase) may vary due to the hot deformation processing. However, by performing the annealing treatment, the variation in the distance between crystals can be removed, and a rare earth magnet having uniform coercive force over the entire region of the magnet can be manufactured.

By the grain boundary phase containing Nd_{1.1}Fe₄B₄ in a content range of 50 mass % or less, that is, by controlling the B content in the grain boundary phase to be in a predetermined range, a decrease in the amount of the main phase during the annealing treatment is suppressed and thus a decrease in magnetization is suppressed.

The grain boundary phase constituting the rare earth magnet precursor contains Ga, Al, Cu, Co, or the like in addition to Nd or the like. As a result, the grain boundary phase can be melted and flow in a low temperature range of, for example, 450° C. to 700° C., and Nd or the like and Ga, Al, Cu, Co, or the like can be alloyed. That is, by alloying a transition metal element or the like and a light rare earth element contained in the grain boundary phase in advance, without the necessity for the diffusion infiltration of a modified alloy from the surface of a magnet, the same modification effects as in the case of the diffusion infiltration of a modified alloy can be exhibited.

In another embodiment of the method of manufacturing a rare earth magnet according to the invention, in the third step, during the annealing treatment, a modified alloy containing a transition metal element and a light rare earth element is diffusely infiltrated into a grain boundary phase.

The modified alloy is diffusely infiltrated into the grain boundary phase during the annealing treatment, the grain boundary phase of the surface region of the rare earth magnet precursor into which the modified alloy is easily diffusely infiltrated is further modified. As a result, the coercive force can be further improved.

The modification of the grain boundary phase, which is performed by alloying a transition metal element or the like and a light rare earth element present in the grain boundary phase in advance, is performed on the grain boundary phase of the entire region of the rare earth magnet precursor. Accordingly, the modification of the grain boundary phase can be sufficiently performed on a center region of the rare earth magnet precursor without the necessity for the diffusion infiltration of the modified alloy into the center region.

By using the modified alloy containing a transition metal element and a light rare earth element, when the annealing treatment is performed in a relatively low temperature range of, for example, 450° C. to 700° C., the melting and the diffusion infiltration of the modified alloy into the grain boundary phase; and the alloying of a transition metal element and a light rare earth element in the grain boundary phase can be performed at the same time.

Examples of the modified alloy containing a transition metal element and a light rare earth element and having a melting point or a eutectic temperature in the above-described temperature range of 450° C. to 700° C. include an alloy containing a light rare earth element such as Nd or Pr and a transition metal element such as Cu, Mn, In, Zn, Al, Ag, Ga, or Fe. More specific examples of the modified alloy include a Nd—Cu alloy (eutectic point: 520° C.), a Pr—Cu alloy (eutectic point: 480° C.), a Nd—Pr—Cu alloy, a Nd—Al alloy (eutectic point: 640° C.), a Pr—Al alloy (650° C.), and a Nd—Pr—Al alloy.

As can be seen from the above description, in the method of manufacturing a rare earth magnet according to the invention, after the hot deformation processing, the rare earth magnet precursor is cooled, and the cooling rate thereof is controlled such that a liquid phase present in a grain boundary phase between crystals is rapidly immobilized (structure freezing). As a result, a decrease in the amount (thickness) of a liquid phase present in a grain boundary phase can be suppressed, in which the decrease is caused when the liquid phase aggregates in small cracks (internal vacuum) formed in crystals of a rare earth magnet precursor which is manufactured by hot deformation processing. Since the decrease in the amount of the liquid phase present in the grain boundary phase is suppressed, a decrease in the coercive force of the rare earth magnet precursor can be suppressed, and thus a rare earth magnet having superior coercive force performance can be manufactured.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a schematic diagram showing a first step of a method of manufacturing a rare earth magnet according to the invention in the order of FIG. 1A and FIG. 1B;

FIG. 1B is a schematic diagram showing the first step of the manufacturing method according to the invention in the order of FIG. 1A and FIG. 1B;

FIG. 1C is a schematic diagram showing a second step of the manufacturing method according to the invention;

FIG. 2A is a diagram showing a microstructure of a sintered compact shown in FIG. 1B;

FIG. 2B is a diagram showing a microstructure of a rare earth magnet precursor shown in FIG. 1C;

FIG. 3 is a schematic diagram showing a state where a grain boundary phase aggregates in a crack in crystals;

FIG. 4A is a schematic diagram showing a third step of the manufacturing method according to the invention;

FIG. 4B is a schematic diagram showing the third step of the manufacturing method according to the invention;

FIG. 4C is a schematic diagram showing the third step of the manufacturing method according to the invention;

FIG. 4D is a schematic diagram showing the third step of the manufacturing method according to the invention;

FIG. 5A is a schematic diagram showing an additional treatment method after cooling in the third step of the manufacturing method according to the invention;

FIG. 5B is a schematic diagram showing the additional treatment method after cooling in the third step of the manufacturing method according to the invention;

FIG. 6 is a diagram illustrating a microstructure of a crystal structure of the manufactured rare earth magnet;

FIG. 7A is an SEM image showing a liquid-phase pool which is pressed out due to stress during hot deformation processing;

FIG. 7B is an SEM image showing the inside of a rare earth magnet precursor after hot deformation processing;

FIG. 8A is an SEM image showing a state where an aggregated liquid phase is crystallized in a crack;

FIG. 8B is an SEM image showing a vacant crack;

FIG. 9 is a graph showing the experiment results specifying a relationship between the cooling rate during cooling after hot deformation processing and the coercive force of the manufactured rare earth magnet;

FIG. 10 is a graph showing the experiment results specifying a relationship between the cooling rate during cooling and the coercive force in a method of manufacturing a rare earth magnet in which an annealing treatment is performed after cooling;

FIG. 11 is a graph showing the experiment results specifying a relationship between the cooling rate during cooling and the coercive force in a method of manufacturing a rare earth magnet in which an annealing treatment is performed after cooling and 3% of a modified alloy is diffusely infiltrated; and

FIG. 12 is a graph showing the experiment results specifying a relationship between the cooling rate during cooling and the coercive force in a method of manufacturing a rare earth magnet in which an annealing treatment is performed after cooling and 5% of a modified alloy is diffusely infiltrated.

### DETAILED DESCRIPTION OF EMBODIMENTS

(Embodiment 1 of Method of Manufacturing Rare Earth Magnet)

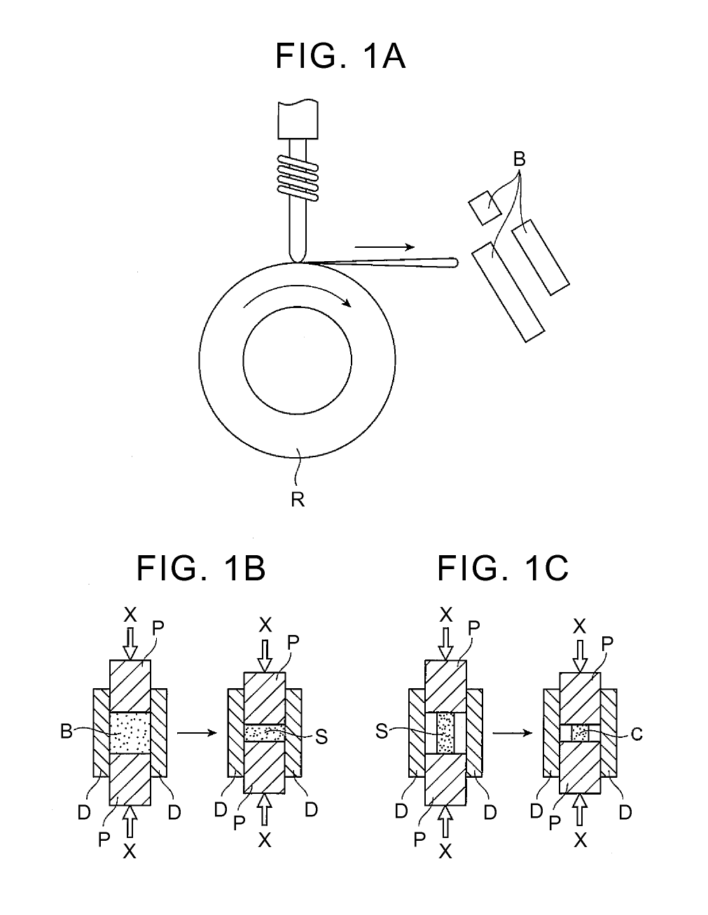

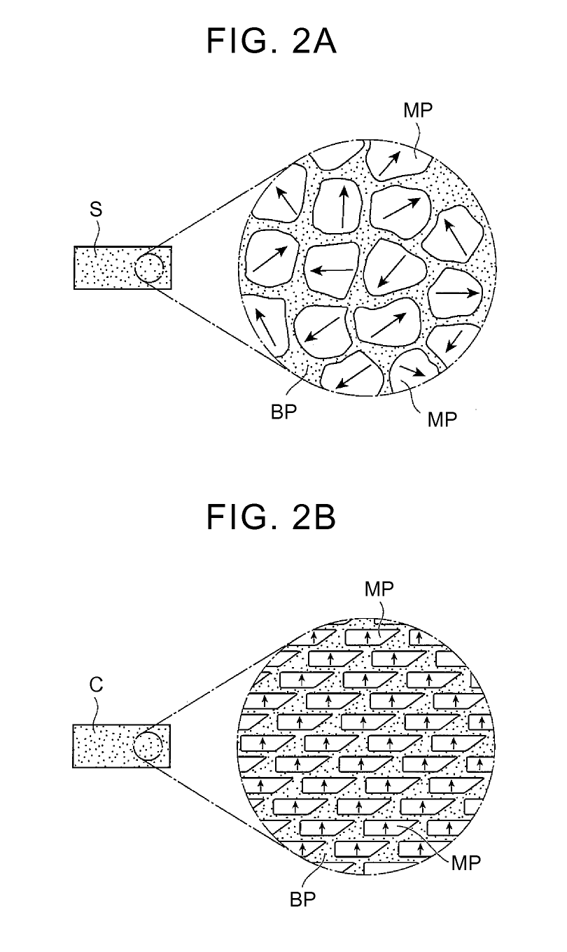

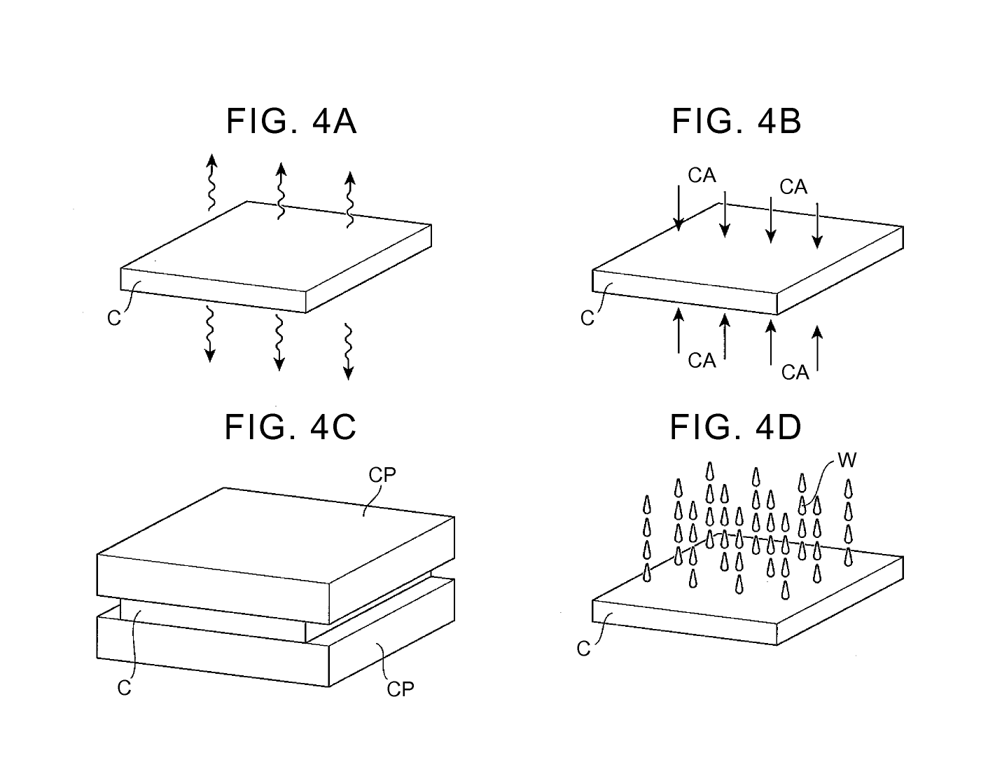

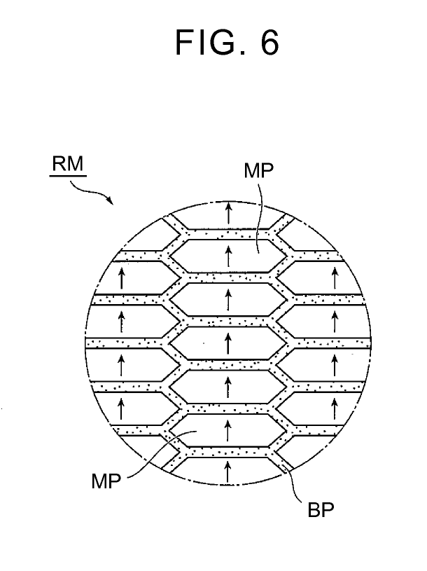

FIGS. 1A and 1B are schematic diagrams showing a first step of a method of manufacturing a rare earth magnet according to an embodiment of the invention in the order of FIG. 1A and FIG. 1B, and FIG. 1C is a schematic diagram illustrating a second step thereof. In addition, FIGS. 4A to 4D are schematic diagrams showing a third step of the manufacturing method according to the invention. In addition, FIG. 2A is a diagram illustrating a microstructure of a sintered compact shown in FIG. 1B, and FIG. 2B is a diagram illustrating a microstructure of a rare earth magnet precursor shown in FIG. 1C. Further, FIG. 6 is a diagram showing a microstructure of a crystal structure of the manufactured rare earth magnet.

As shown in FIG. 1A, in a furnace (not shown) of an Ar gas atmosphere in which the pressure is reduced to, for example, 50 kPa or lower, an alloy ingot is melted by high-frequency induction heating using a single-roll melt spinning method, and molten metal having a composition of a rare earth magnet is injected to a copper roll R to prepare a quenched ribbon B, and this quenched ribbon B is crushed.

As shown in FIG. 1B, the crushed quenched ribbon B is filled into a cavity which is partitioned by a cemented carbide die D and a cemented carbide punch P sliding in a hollow portion of the cemented carbide die D. Next, the crushed quenched ribbon B is heated by causing a current to flow therethrough in a compression direction while being compressed with the cemented carbide punch P (X direction). As a result, a sintered compact S having a structure represented by (Rl)ₓ(Rh)_{y}T_{z}BₛMₜ (Rl represents one or more light rare earth elements containing Y, Rh represents a heavy rare earth element containing at least one of Dy and Tb, T represents a transition metal containing at least one of Fe, Ni, and Co, B represents boron, M represents at least one of Ti, Ga, Zn, Si, Al, Nb, Zr, Ni, Co, Mn, V, W, Ta, Ge, Cu, Cr, Hf, Mo, P, C, Mg, Hg, Ag, and Au, 12≦x≦20, 0≦y≦4, z=100-x-y-s-t, 5≦s≦20, 0≦t≦3 (all the numerical values are represented by mass %)) and containing a main phase and a grain boundary phase is manufactured. The main phase has a grain size of about 50 nm to 300 nm (hereinabove, the first step).

The grain boundary phase contains at least one of Ga, Al, Cu, Co, and the like in addition to Nd or the like and is in a Nd-rich state. In addition, the grain boundary phase contains a Nd phase and a Nd_{1.1}T₄B₄ phase as major components, in which the content of the Nd_{1.1}T₄B₄ phase is controlled to be in a range of more than 0 mass % and 50 mass % or less.

As shown in FIG. 2A, the sintered compact S has an isotropic crystal structure in which the grain boundary phase BP is filled between nanocrystalline grains MP (main phase). In order to impart magnetic anisotropy to the sintered compact S, as shown in FIG. 1C, the cemented carbide punch P is brought into contact with an end surface of the sintered compact S in a longitudinal direction thereof (in FIG. 1B, the horizontal direction is the longitudinal direction) such that hot deformation processing is performed on the sintered compact S while being compressed with the cemented carbide punch P (X direction). As a result, a rare earth magnet precursor C which includes a crystal structure having the anisotropic nanocrystalline grains MP as shown in FIG. 2B is manufactured (hereinabove, the second step).

When the processing degree (compressibility) by the hot deformation processing is high, for example, when the compressibility is about 10% or higher, this processing may be called high hot deformation or simply high deformation. However, it is preferable that high deformation is performed at a compressibility of about 60% to 80%.

In a crystal structure of the rare earth magnet precursor C shown in FIG. 2B, the nanocrystalline grains MP have a flat shape, and the boundary surface which is substantially parallel to an anisotropic axis is curved or bent and is not configured of a specific surface.

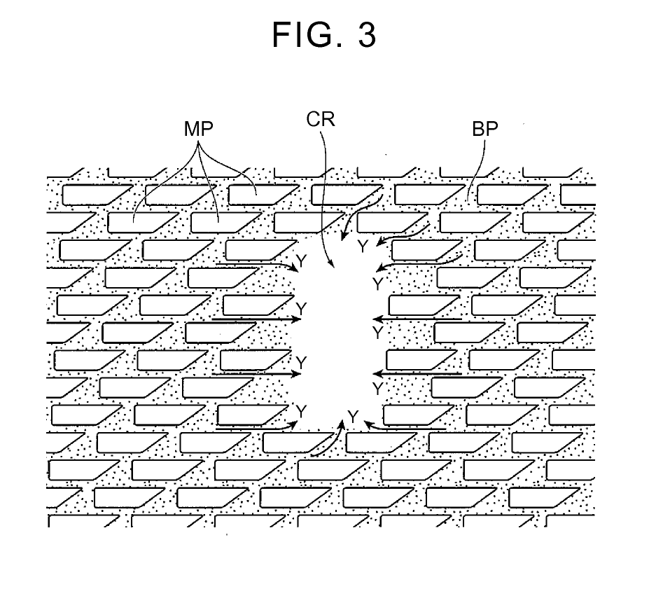

Here, FIG. 3 is a schematic diagram showing a state where a grain boundary phase aggregates in a crack in crystals. Due to the hot deformation processing shown in FIG. 1C, a small crack may be formed in crystals of the manufactured rare earth magnet precursor C as shown in FIG. 3.

That is, during the hot deformation processing, a small crack CR (internal vacuum) is formed in crystals, and a liquid phase in the grain boundary phase BP flows (Y direction) into the small crack CR and aggregates therein. By the liquid phase in the grain boundary phase BP flowing into the small crack CR, the amount (thickness) of the liquid phase in the grain boundary phase BP decreases, which causes a decrease in coercive force.

In the second step, after the rare earth magnet precursor C is manufactured through the hot deformation processing, in the third step, the rare earth magnet precursor C is cooled, and the cooling rate thereof is controlled. As a result, the liquid phase present in the grain boundary phase BP between crystals is rapidly immobilized (structure freezing).

Examples of a cooling method include methods according to four embodiments shown in FIGS. 4A to 4D. In the cooling method shown in FIG. 4A, the rare earth magnet precursor C is left to stand at room temperature to be cooled. In the cooling method shown in FIG. 4B, air CA is blown to the rare earth magnet precursor C to be forcedly air-cooled. In the cooling method shown in FIG. 4C, the rare earth magnet precursor C is interposed between two copper plates CP to perform copper plate contact cooling. In the cooling method shown in FIG. 4D, water W is supplied to the rare earth magnet precursor C for water cooling.

Using the above-described methods, the rare earth magnet precursor C which is heated to about, for example, 800° C. is cooled. As a result, a rare earth magnet is manufactured. In any of the methods according to the various embodiments, it is important to cool at the cooling rate of 10° C./sec or higher.

The cooling rate is determined based on the experiment results below by the present inventors. By cooling the rare earth magnet precursor C at a cooling rate of 10° C./sec or higher, a rare earth magnet RM having superior coercive force performance as shown in FIG. 6 can be obtained.

The rare earth magnet precursor C which is heated to about 800° C. is cooled at a cooling rate in the above-described range. Once the temperature of the rare earth magnet precursor is decreased to about 550° C., the structure freezing of the liquid phase occurs.

(Embodiment 2 of Method of Manufacturing Rare Earth Magnet)

A method of manufacturing a rare earth magnet according to Embodiment 2 includes the same steps as those before the cooling in the third step of the manufacturing method according to Embodiment 1. In the third step, after the cooling, the following two treatments are additionally performed.

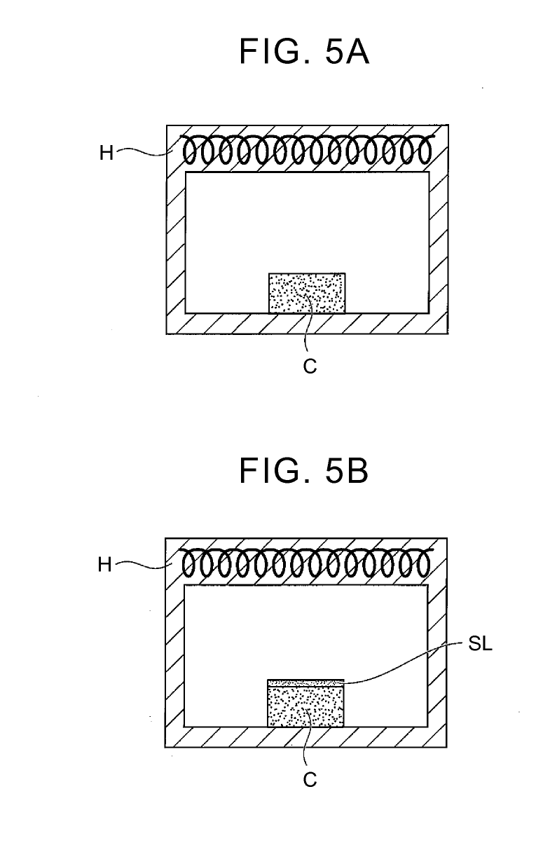

In a first method, as shown in FIG. 5A, after the cooling, the rare earth magnet precursor C is put into a high-temperature furnace H, and only an annealing treatment is performed on the rare earth magnet precursor C in a temperature range of 450° C. to 700° C.

The grain boundary phase constituting the rare earth magnet precursor C contains at least one of Ga, Al, Cu, and Co in addition to Nd or the like. As a result, the grain boundary phase BP can be melted and flow in a low temperature range of 450° C. to 700° C., and Nd or the like and Ga, Al, Cu, Co, or the like can be alloyed. That is, by alloying a transition metal element or the like and a light rare earth element contained in the grain boundary phase in advance, without the necessity for the diffusion infiltration of a modified alloy from the surface of a magnet, the same modification effects as in the case of the diffusion infiltration of a modified alloy can be exhibited. By performing the annealing treatment after the cooling, a variation in the distance between crystals (the width of the grain boundary phase) caused by hot deformation processing can be removed. In this way, the transition metal element and the light rare earth element contained in the grain boundary phase in advance are alloyed, and the variation in the distance between crystals is removed. As a result, a rare earth magnet having uniform and high coercive force over the entire region of the magnet can be manufactured.

Further, by the grain boundary phase BP containing Nd_{1.1}Fe₄B₄ in a content range of 50 mass % or less, that is, by controlling the boron content (B content) in the grain boundary phase BP to be in a predetermined range, a decrease in the amount of the main phase during the annealing treatment is suppressed and thus a decrease in magnetization is suppressed.

As a result, the coercive force can be improved by the annealing treatment, and a decrease in magnetization caused by the annealing treatment can be suppressed. Accordingly, a rare earth magnet which is superior in both coercive force performance and magnetization performance can be manufactured.

On the other hand, in a second method, as shown in FIG. 5B, after the cooling, modified alloy powder SL is sprayed on the surface of the rare earth magnet precursor C, the rare earth magnet precursor C is put into a high-temperature furnace H, and the modified alloy SL is diffusely infiltrated while performing the annealing treatment on the rare earth magnet precursor C in a temperature range of 450° C. to 700° C.

Regarding the modified alloy powder SL, a plate-shaped modified alloy powder may be placed on the surface of the rare earth magnet precursor, or a slurry of the modified alloy powder may be prepared and coated on the surface of the rare earth magnet precursor.

Here, the modified alloy powder SL contains a transition metal element and a light rare earth element, and a modified alloy having a low eutectic point of 450° C. to 700° C. is used. As the modified alloy powder SL, for example, any one of a Nd—Cu alloy (eutectic point: 520° C.), a Pr—Cu alloy (eutectic point: 480° C.), a Nd—Pr—Cu alloy, a Nd—Al alloy (eutectic point: 640° C.), a Pr—Al alloy (eutectic point: 650° C.), a Nd—Pr—Al alloy, a Nd—Co alloy (eutectic point: 566° C.), a Pr—Co alloy (eutectic point: 540° C.), and a Nd—Pr—Co alloy is preferably used. Among these, alloys having a low eutectic point of 580° C. or lower, for example, a Nd—Cu alloy (eutectic point: 520° C.), a Pr—Cu alloy (eutectic point: 480° C.), a Nd—Co alloy (eutectic point: 566° C.), and a Pr—Co alloy (eutectic point: 540° C.) are more preferably used.

The modified alloy is diffusely infiltrated into the grain boundary phase in this way, the grain boundary phase BP of the rare earth magnet precursor C, particularly on the surface region of the rare earth magnet precursor C, can be further modified. That is, the grain boundary phase BP of the entire region of the rare earth magnet precursor C can be modified by the alloying of the transition metal element and the light rare earth element in the grain boundary phase BP. Therefore, it is not necessary that the non-magnetic modified alloy SL is diffusely infiltrated into the center region of the rare earth magnet precursor C to modify the grain boundary phase BP.

No matter which method is used among the methods shown in FIGS. 5A and 5B, Nd or the like and at least one of Ga, Al, Cu, and Co present in the grain boundary phase of the rare earth magnet precursor C in advance are alloyed by the annealing treatment to modify the grain boundary phase BP. Further, a predetermined amount of boron is present in the grain boundary phase BP. Accordingly, the crystal structure of the rare earth magnet precursor C shown in FIG. 2B is changed, the boundary surface of the crystal grains MP is clearly defined as shown in FIG. 6, the crystal grains MP are magnetically isolated from each other, and a rare earth magnet RM having an improved coercive force is manufactured. In an intermediate step of the structure modification by the modified alloy shown in FIG. 6, a boundary surface which is substantially parallel to an anisotropic axis is not formed (is not configured of a specific surface). However, in a step in which the modification by the modified alloy sufficiently progresses, a boundary surface (specific surface) which is substantially parallel to an anisotropic axis is formed, and a rare earth magnet in which the shape of the crystal grains MP is rectangular or substantially rectangular when seen from a direction perpendicular to the anisotropic axis is manufactured.

Experiment Specifying Relationship between Cooling Rate During Cooling After Hot Deformation Processing and Coercive Force of Rare Earth Magnet; and Results Thereof)

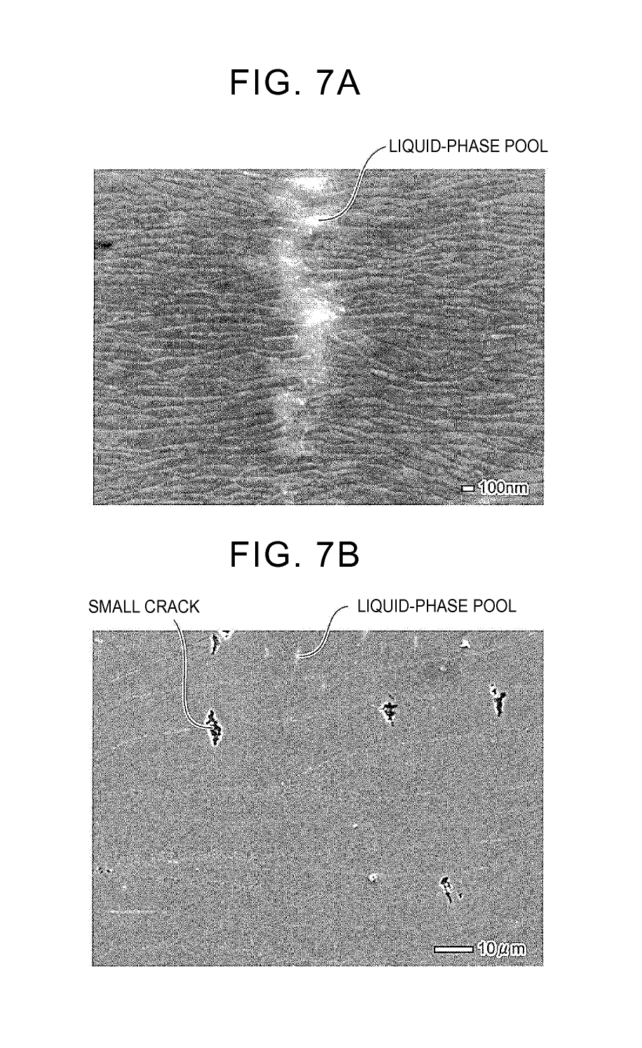

The present inventors performed an experiment specifying a relationship between the cooling rate during cooling after hot deformation processing and the coercive force of the manufactured rare earth magnet. Before the description of the experiment, an effect of hot deformation processing on crystals will be described with reference to FIG. 7 showing an SEM image of a crystal structure of a rare earth magnet precursor after hot deformation processing.

<Effect of Hot Deformation Processing on Crystals>

FIG. 7A is an SEM image showing a liquid-phase pool which is pressed out due to stress during hot deformation processing. FIG. 7B is an SEM image showing the inside of a rare earth magnet precursor after hot deformation processing.

As shown in FIG. 7A, due to high stress which is applied to crystals during hot deformation processing, a liquid phase in a grain boundary phase is pressed out so as to locally form a liquid-phase pool. This liquid-phase pool causes disorder in the peripheral orientation, which causes deterioration in the magnetic characteristics of the rare earth magnet.

In addition, as shown in FIG. 7B, due to tensile stress generated by a difference in material flowing speed between the inside and the surface of a sample during hot deformation processing, a small crack formed in crystals is initiated from the liquid-phase pool. The inside of the small crack is a vacuum and has a force of drawing the peripheral liquid phase. By the liquid phase being drawn into the small crack, the thickness of the grain boundary phase near the crack is reduced, which causes a decrease in the coercive force of a rare earth magnet.

<Experiment Method>

Raw materials of a rare earth magnet (an alloy composition was Fe-30Nd-0.93B-4Co-0.4Ga by mass %) were mixed in predetermined amounts, the mixture was melted in an Ar atmosphere, and the molten metal was injected from a (φ0.8 mm orifice into a Cr-plated Cu rotating roll to be quenched. As a result, a quenched ribbon was manufactured. This quenched ribbon was crushed using a cutter mill in an Ar atmosphere to obtain a magnetic powder for a rare earth magnet having a grain size of 0.3 mm or less. The obtained magnetic powder was put into a cemented carbide die having a size of 7 mm×29 mm×19 mm, and the top and the bottom thereof were sealed with a cemented carbide punch. Next, the magnetic powder was set in a chamber and was pressed to 400 MPa by reducing the pressure to 10⁻² Pa and then heating the mold to 650° C. using a high-frequency coil. After the pressing, the magnetic powder was held at this state for 20 minutes to prepare a sintered compact, and the sintered compact was pulled out from the mold. Next, the prepared sintered compact was coated with a lubricant and dried, was heated to about 800° C. using a high-frequency coil, and was transported and put into a mold heated to about 800° C. Next, 70% ((Thickness before Processing—Thickness of after Processing)/Thickness before Processing) of hot deformation processing (forging) was performed at a stroke speed of 2 mm/sec (a strain rate of about 0.1/sec) to prepare a rare earth magnet precursor. Finally, the prepared rare earth magnet precursor was cooled by, for example, natural cooling or forced air-cooling to prepare a rare earth magnet as a specimen.

Plural specimens were prepared while changing the cooling rate to various values. The coercive force of each specimen was measured using a pulse excitation magnetic characteristic specifying device (TPM).

(Experiment Results)

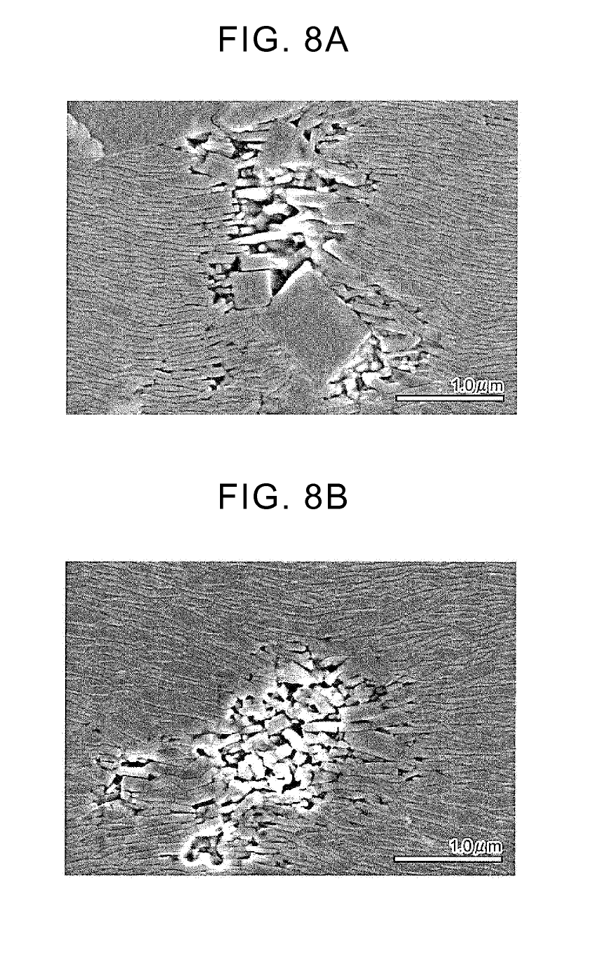

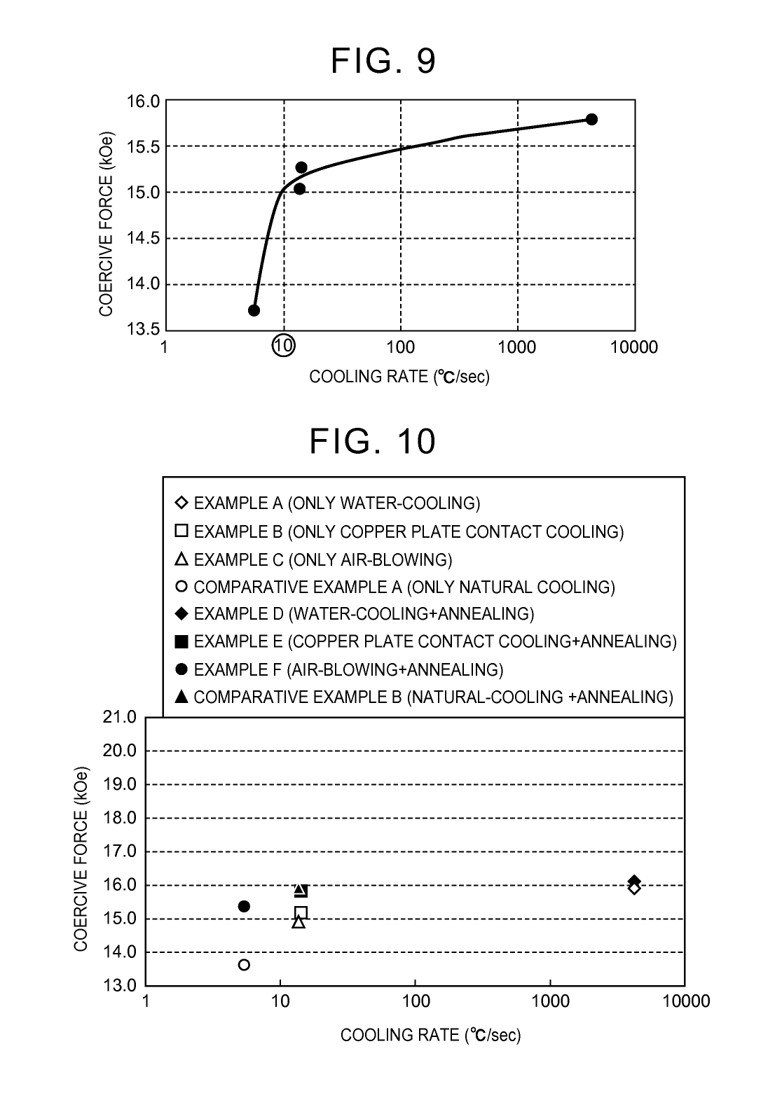

The experiment results are shown in FIGS. 8 and 9. FIG. 8A is an SEM image showing a structure of a specimen which was prepared by performing natural cooling (cooling rate: 4° C./sec) after hot deformation processing. It can be verified from FIG. 8A that an aggregated liquid phase in a crack is crystallized by cooling.

FIG. 8B is an SEM image showing a structure of a specimen which was prepared by performing forced air-cooling (cooling rate: 14° C./sec) after hot deformation processing. It can be verified that the inside of a crack is maintained to be vacant.

Further, it was verified from FIG. 9 that, according to an approximation curve which was formed by plotting the respective experiment results, the coercive force had an inflection point of the graph at a cooling rate of 10° C./sec or higher, rapidly increased at a cooling rate of lower than 10° C./sec, and was converged in a range of 15 kOe to 16 kOe at a cooling rate of lower than 10° C./sec or higher. Based on the experiment results, during cooling after hot deformation processing, the cooling rate was set to be 10° C./sec or higher.

(Experiment for Verifying Effects of Method of Performing Annealing Treatment after Cooling and Effects of Method of Performing not only Annealing Treatment but also Diffusion nInfiltration of Modified Alloy after Cooling; and Results Thereof)

The present inventors performed an experiment for verifying the effects of the method of performing not only cooling but also the annealing treatment after the hot deformation processing and the effects of performing not only the annealing treatment but also the diffusion infiltration of the modified alloy.

<Experimental Method>

Examples underwent any one of three kinds of cooling methods (cooling rates) including water-cooling (4190° C./sec), copper plate contacting (14° C./sec), and air-blowing (13° C./sec). In each cooling method, there were three cases including: a case where an annealing treatment (no diffusion infiltration of the modified alloy) was performed under conditions of a vacuum degree of 10⁻³ Pa, a heat treatment temperature of 580° C., and a heat treatment time of 300 minutes; a case where 3% of a Nd—Cu alloy was diffusely infiltrated; and a case where 5% of a Nd—Cu alloy was diffusely infiltrated. On the other hand, Comparative Examples underwent natural cooling (5° C./sec) as a cooling method (cooling rate). In the cooling method, there were three cases including: a case where an annealing treatment (no diffusion infiltration of the modified alloy) was performed under conditions of a vacuum degree of 10⁻³ Pa, a heat treatment temperature of 580° C., and a heat treatment time of 300 minutes; a case where 3% of a Nd—Cu alloy was diffusely infiltrated; and a case where 5% of a Nd—Cu alloy was diffusely infiltrated.

(Experiment Results)

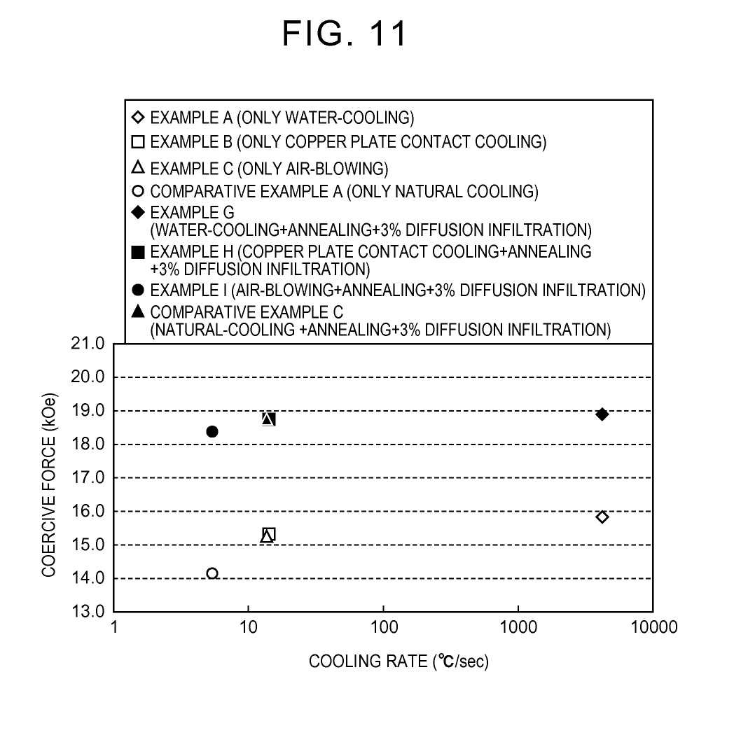

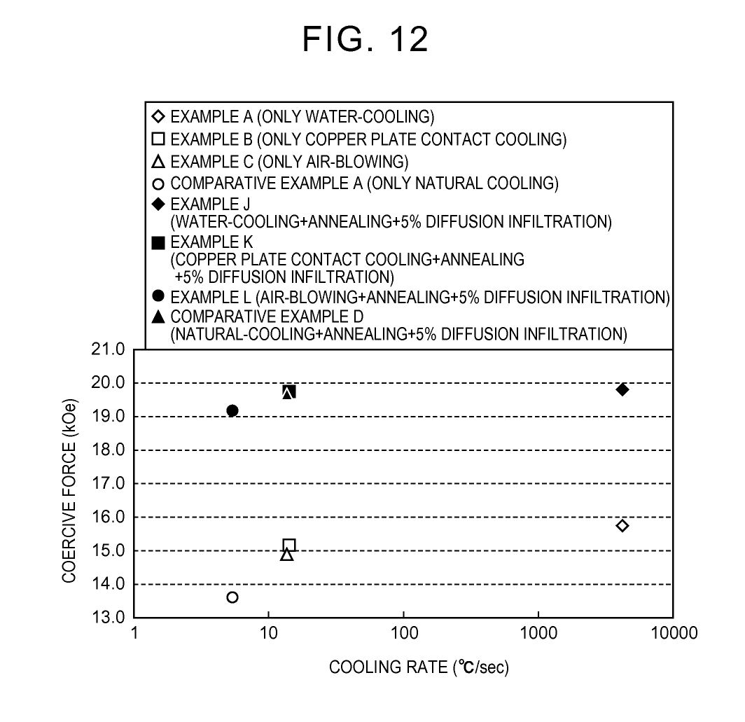

The experiment results are shown in FIGS. 10 and 12. FIG. 10 is a graph showing a relationship between the cooling rate during cooling and the coercive force of the rare earth magnet when only the annealing treatment was performed after cooling. FIG. 11 is a graph showing a relationship between the cooling rate during cooling and the coercive force of the rare earth magnet when the annealing treatment was performed and 3% of a Nd—Cu alloy was diffusely infiltrated after cooling. FIG. 12 is a graph showing a relationship between the cooling rate during cooling and the coercive force of the rare earth magnet when the annealing treatment was performed and 5% of a Nd—Cu alloy was diffusely infiltrated after cooling.

It was verified from FIG. 10 that, in each Example, the coercive force was improved by about 0.6 kOe as compared to each Comparative Example. Here, the maximum value of the coercive force is determined based on the amount of the grain boundary phase present in crystals. It was verified from FIG. 10 that, in all the Examples, the coercive force was improved by cooling the rare earth magnet precursor at a cooling rate of 10° C./sec or higher and then annealing the cooled rare earth magnet precursor. Among Examples, in the case of water-cooling (4190° C./sec), the coercive force improvement effect was more significant as compared to the case of air-blowing (13° C./sec). This is because the aggregation of Nd or the like in a small crack can be more efficiently suppressed due to the cooling at a higher cooling rate. This is also because the coercive force is improved due to the above effect and the effect of reducing a variation in the distance between crystals caused by annealing.

It was verified from FIG. 11 that, in each Example, the coercive force was improved by about 0.5 kOe as compared to each Comparative Example. It was verified from a comparison to the results of FIG. 10 that the coercive force was improved by about 3 kOe by performing the annealing treatment and processing that 3% of the modified alloy is diffusely infiltrated after cooling.

Further, it was verified from FIG. 12 that, in each Example, the coercive force was improved by about 0.6 kOe as compared to each Comparative Example. It was verified from a comparison to the results of FIG. 11 that the coercive force was further improved by about 1 kOe by performing the annealing treatment and processing that 5% of the modified alloy is diffusely infiltrated after cooling.

The following facts were verified. The coercive force improvement effect can be expected by performing not only cooling but also the annealing treatment. Further, due to the diffusion infiltration of the modified alloy, further improvement of coercive force can be expected.

Hereinabove, the embodiments of the invention have been described with reference to the drawings. However, a specific configuration is not limited to the embodiments, and design changes and the like which are made within a range not departing from the scope of the invention are included in the invention.

What is claimed is:

1. A method of manufacturing a rare earth magnet, the method comprising:
manufacturing a sintered compact by press-forming a powder for the rare earth magnet;
manufacturing a rare earth magnet precursor by performing hot deformation processing on the sintered compact to impart anisotropy to the sintered compact; and
manufacturing the rare earth magnet by cooling the rare earth magnet precursor at a cooling rate of 10° C./sec or higher.

2. The method of manufacturing the rare earth magnet according to claim 1, wherein
when the rare earth magnet is manufactured by cooling the rare earth magnet precursor at a cooling rate of 10° C./sec or higher, after the cooling of the rare earth magnet precursor, an annealing treatment is performed.

3. The method of manufacturing the rare earth magnet according to claim 1, wherein
when the rare earth magnet is manufactured by cooling the rare earth magnet precursor at a cooling rate of 10° C./sec or higher, after the cooling of the rare earth magnet precursor, an annealing treatment is performed, and a modified alloy containing a transition metal element and a light rare earth element is diffusely infiltrated into a grain boundary phase.

4. The method of manufacturing the rare earth magnet according to claim 1, wherein
when the sintered compact is manufactured by press-forming the powder for the rare earth magnet, the sintered compact contains a structure,
the structure is represented by a compositional formula (Rl)ₓ(Rh)_{y}T_{z}BₛMₜ, where Rl represents one or more light rare earth elements containing Y, Rh represents a heavy rare earth element containing at least one of Dy and Tb, T represents a transition metal containing at least one of Fe, Ni, and Co, B represents boron, M represents at least one of Ti, Ga, Zn, Si, Al, Nb, Zr, Ni, Co, Mn, V, W, Ta, Ge, Cu, Cr, Hf, Mo, P, C, Mg, Hg, Ag, and Au, 12≦x≦20, 0≦y≦4, z=100-x-y-s-t, and all the numerical values are represented by mass %,
a main phase of the structure is formed of (RlRh)₂T₁₄B, and
a content of a (RlRh)_{1.1}T₄B₄ phase in a grain boundary phase of the structure is more than 0 mass % and 50 mass % or less.
